(19) United States
(12) Patent Application Publication
(10) Pub. No.: US 2025/0379317 A1
(43) Pub. Date: Dec. 11, 2025

(54) Reversible Battery Pack Assembly for Battery Electric Vehicles

(71) Applicant: THE REGENTS OF THE UNIVERSITY OF MICHIGAN, ANN ARBOR, MI (US)

(72) Inventor: Kazuhiro Saitou, ANN ARBOR, MI (US)

(21) Appl. No.: 19/228,980

(22) Filed: Jun. 5, 2025

Related U.S. Application Data
(60) Provisional application No. 63/658,198, filed on Jun. 10, 2024.

(51) Int. Cl. H01M 50/258; B60L 53/80; H01M 50/207; H01M 50/249; H01M 50/271; H01M 50/514

(52) U.S. Cl. CPC H01M 50/258; B60L 53/80; H01M 50/207; H01M 50/271; H01M 50/514; H01M 50/249

(57) ABSTRACT

A battery pack comprises an enclosure, and a plurality of batteries arranged within the enclosure. Each battery includes one or more electrochemical cells, and a case structured to contain the one or more electrochemical cells in an interior space of the case. Each case comprises a first end wall, an opposite second end wall, and a multi-sided wall connecting the first end wall and the second end wall thereby defining the interior space of the case. A multi-sided wall of the case of at least one of the batteries comprises at least one inwardly directed recess having a first section dimensioned to matingly engage a second section of a multi-sided wall of another of the batteries when the plurality of batteries are arranged within the enclosure.

### CROSS-REFERENCES TO RELATED APPLICATIONS

This application is based on, claims benefit of, and claims priority to U.S. Application No. 63/658,198 filed on Jun. 10, 2024, which is hereby incorporated by reference herein in its entirety for all purposes.

### STATEMENT REGARDING FEDERALLY SPONSORED RESEARCH

Not Applicable.

### BACKGROUND OF THE INVENTION

### 1. Field of the Invention

This invention relates to a battery pack that allows for non-destructive selective disassembly of individual batteries for replacement and/or repair.

### 2. Description of the Related Art

Most electric vehicle battery packs are built from groups of cells housed in modules interconnected within an enclosure that provides structural support and connectivity with the rest of the drivetrain. This has been called a cell-to-module method. Cell-to-module batteries configure the cells into small groups called modules. The modules are then assembled to create a full vehicle's battery pack.

In an alternative method, modules can be eliminated, and battery packs can be built up from cells inside the enclosure in what is known as the cell-to-pack arrangement. The cell-to-pack approach simplifies assembly. However, cell-to-pack assembly makes it difficult to repair and replace individual battery cells, particularly when bolts and/or adhesives are used to fasten individual battery cells.

What is needed therefore is a battery pack that allows for quick, non-destructive selective disassembly of individual batteries for replacement and/or repair.

### SUMMARY OF THE INVENTION

The present disclosure meets the foregoing needs by providing a battery pack that allows for quick, non-destructive selective disassembly of individual batteries for replacement and/or repair, which is very difficult, if not impossible, for the current cell-to-pack/body designs that utilize bolts/adhesives to fasten individual cells.

In one aspect, the present disclosure provides a battery pack comprising an enclosure, and a plurality of batteries arranged within the enclosure. Each battery includes one or more electrochemical cells, and a case structured to contain the one or more electrochemical cells in an interior space of the case. Each case comprises a first end wall, an opposite second end wall, and a multi-sided wall connecting the first end wall and the second end wall thereby defining the interior space of the case. A multi-sided wall of the case of at least one of the batteries comprises at least one inwardly directed recess having a first section dimensioned to matingly engage a second section of a multi-sided wall of another of the batteries when the plurality of batteries are arranged within the enclosure.

In one embodiment of the battery pack, the first section of the multi-sided wall of the case of the at least one of the batteries is dimensioned to matingly engage a third section of a multi-sided wall of an additional one of the batteries when the plurality of batteries are arranged within the enclosure. In one embodiment of the battery pack, a first end wall of the case of the another of the batteries matingly engages a second end wall of the additional one of the batteries when the plurality of batteries are arranged within the enclosure.

In one embodiment of the battery pack, the enclosure comprises a floor, a plurality of connected side walls extending upward from the floor and defining an opening between a pair of the connected side walls, and a removable side wall dimensioned to close off the opening. In one embodiment of the battery pack, the removable side wall is adhered to the pair of the connected side walls using an adhesive to close off the opening. In one embodiment of the battery pack, the adhesive is selected from reversible adhesives that exhibit switchable adhesion controllable by a stimulus. In one embodiment of the battery pack, the stimulus is at least one of a light stimulus, an electrical stimulus, a thermal stimulus, or a magnetic stimulus. In one embodiment of the battery pack, at least one of the pair of the connected side walls includes an indentation dimensioned to matingly engage a third section of the multi-sided wall of the another of the batteries when the plurality of batteries are arranged within the enclosure.

In one embodiment of the battery pack, each of the plurality of batteries has a cross-sectional geometry to form an interlocking pattern of the plurality of batteries when the plurality of batteries are arranged within the enclosure. In one embodiment of the battery pack, the interlocking pattern distributes load evenly among the plurality of batteries cells in a longitudinal direction and a lateral direction due to a preload exerted by the enclosure. In one embodiment of the battery pack, the removable side wall is adhered to the pair of the connected side walls using a reversible adhesive to close off the opening, and the preload is released by debonding the reversible adhesive enabling retrieval of individual batteries of the plurality of batteries in a direction transverse to a longitudinal axis of the enclosure. In one embodiment of the battery pack, the removable side wall is adhered to the pair of the connected side walls using a reversible adhesive to close off the opening, and the preload is released by debonding the reversible adhesive enabling non-destructive selective disassembly of the plurality of batteries.

In one embodiment of the battery pack, the removable side wall is secured to the pair of the connected side walls using screws.

In one embodiment of the battery pack, each electrochemical cell includes a cathode, an anode, a solid state electrolyte positioned between the cathode and the anode, and a current collector in contact with one of the anode or the cathode; and each battery further comprises: (a) one or more electrochemical cells, each electrochemical cell including a cathode, an anode, a solid state electrolyte positioned between the cathode and the anode, and a current collector in contact with one of the anode or the cathode, (b) a first terminal current collector comprising the current collector in contact with the one of the anode or the cathode of one of the electrochemical cells, and (c) a second terminal current collector in contact with (i) the cathode of one of the electrochemical cells when the first terminal current collector comprises the current collector in contact with the anode of one of the electrochemical cells, or (ii) the anode of one of the electrochemical cells when the first terminal current collector comprises the current collector in contact with the cathode of one of the electrochemical cells.

In one embodiment, the battery pack further comprises: a cover dimensioned to engage the plurality of connected side walls and the removable side wall of the enclosure, wherein the cover includes a plurality of electrical contacts for placing the first terminal current collector of one of the plurality of batteries in electrical communication with the second terminal current collector of an adjacent battery of the plurality of batteries, and wherein the plurality of electrical contacts are in electrical communication.

In one embodiment, the battery pack further comprises: a cover dimensioned to engage the plurality of connected side walls and the removable side wall of the enclosure, wherein the cover includes an electrical pattern for placing the first terminal current collector of one of the plurality of batteries in electrical communication with the second terminal current collector of an adjacent battery of the plurality of batteries.

In one embodiment of the battery pack, the multi-sided wall of the case of the at least one of the batteries comprises a first inwardly directed recess on a first side of the multi-sided wall and a second inwardly directed recess on an opposite second side of the multi-sided wall, a first section of the first inwardly directed recess is dimensioned to matingly engage a second section of a multi-sided wall of another of the batteries when the plurality of batteries are arranged within the enclosure, and a second section of the second inwardly directed recess is dimensioned to matingly engage a third section of a multi-sided wall of an additional one of the batteries when the plurality of batteries are arranged within the enclosure.

In one embodiment of the battery pack, the first end wall and the opposite second end wall of the case of at least some of the batteries each have a perimeter having a first end section having a first lateral width, a second end section having a second lateral width, and an intermediate section having a third lateral width, the intermediate section connecting the first end section and the second end section, and the first lateral width is greater than the third lateral width, and the second lateral width is greater than the third lateral width.

In one embodiment of the battery pack, a longitudinal axis of the first end wall and the opposite second end wall of the case of at some of the batteries is an axis of symmetry.

In one embodiment of the battery pack, a lateral axis of the first end wall and the opposite second end wall of the case of at some of the batteries is an axis of symmetry. In one embodiment of the battery pack, the first end wall and the opposite second end wall of the case of at least some of the batteries each have a perimeter having a first end section having a first lateral width, and a second end section having a second lateral width, and the first lateral width is greater than the second lateral width.

In one embodiment of the battery pack, the plurality of batteries are not secured together using fasteners or adhesive when the plurality of batteries are arranged within the enclosure.

It is an advantage of the present disclosure to provide a reversible cell-to-pack assembly for battery electric vehicles (BEVs) with no fasteners, where cells are tiled in a preloaded interlocking pattern in a battery enclosure closed by debondable adhesive. The concept enables quick, non-destructive selective disassembly of individual cells for replacement, which is very difficult, if not impossible, for the current cell-to-pack/body designs that utilize bolts/adhesives to fasten individual cells.

It is another advantage of the present disclosure to provide a cell-to-pack design where bipolar cells are tiled within a battery enclosure closed with debondable adhesive. The enclosures have a cross-sectional geometry that can form an interlocking pattern when tiled. The pattern can be designed in such a way that the preload exerted by the battery enclosure will distribute the load evenly among cells in the x-y-direction. Upon disassembly, the preload is released by debonding the adhesive, enabling the retrieval of individual cells in the z-direction. In one non-limiting example, a reversible adhesive that exhibits switchable adhesion controllable by a stimulus such as a light stimulus, an electrical stimulus, a thermal stimulus, or a magnetic stimulus can offer high durable mechanical strength with high reversibility.

These and other features, aspects, and advantages of the present invention will become better understood upon consideration of the following detailed description, drawings, and appended claims.

### BRIEF DESCRIPTION OF THE DRAWINGS

FIG. 1 is a perspective view of a non-limiting example embodiment of a battery according to the present disclosure with the case shown as transparent for the sake of illustration.

FIG. 2 shows a cross-sectional view of the battery of FIG. 1 taken along line 2-2 of FIG. 1.

FIG. 3 is a perspective view of the case of the battery of FIG. 1.

FIG. 4 is a perspective view of another non-limiting example embodiment of a battery according to the present disclosure with the certain walls of the case shown as transparent for the sake of illustration.

FIG. 5 is a perspective view of a non-limiting example embodiment of a battery pack according to the present disclosure.

FIG. 6 is a perspective view of the battery pack of FIG. 5 with a removable side wall of the battery enclosure removed such that a battery of the battery pack can be removed and replaced.

FIG. 7 is a bottom view of a non-limiting example embodiment of a cover of an enclosure of a battery pack according to the present disclosure.

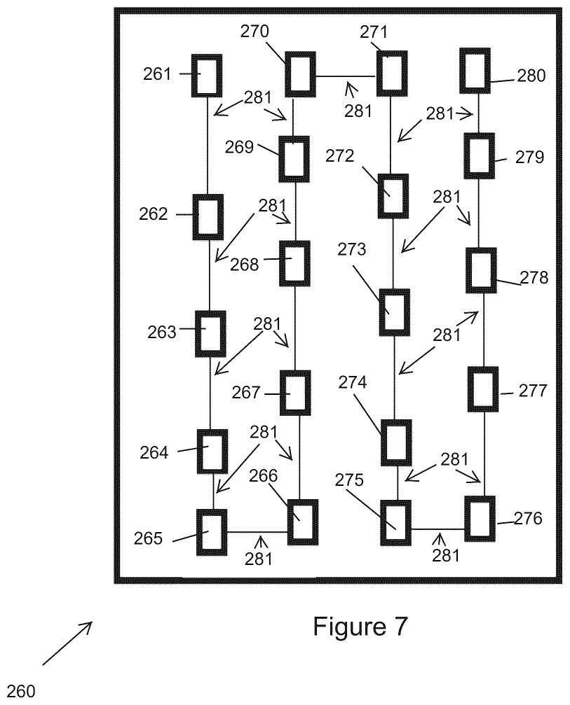

Like reference numerals will be used to refer to like parts from Figure to Figure in the following description of the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. Skilled artisans will recognize the examples provided herein have many useful alternatives and fall within the scope of embodiments of the invention.

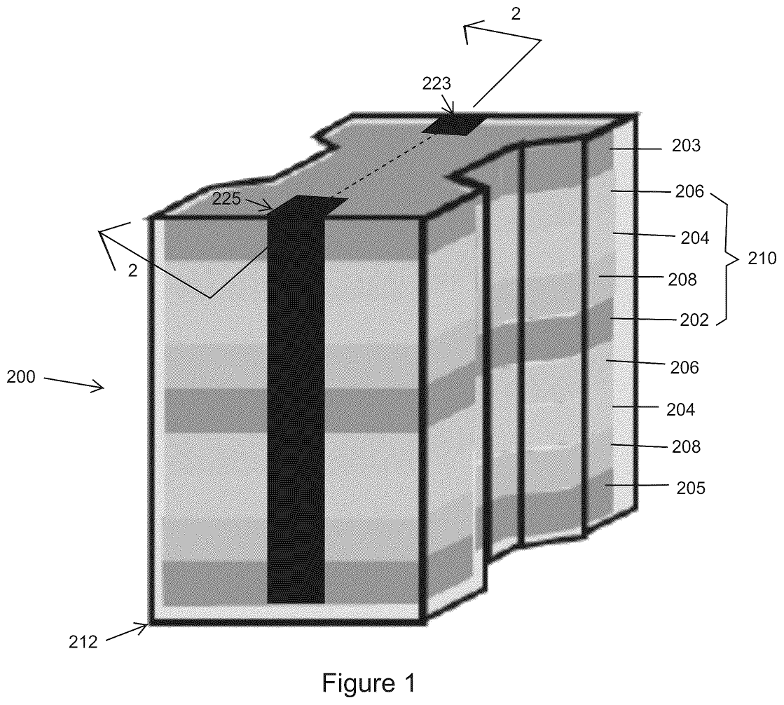

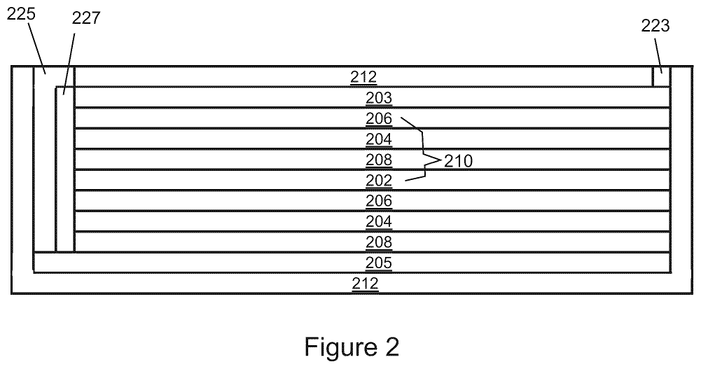

The present invention provides a battery pack comprising an enclosure and a plurality of batteries arranged within the enclosure. FIGS. 1-3 depicts a non-limiting example embodiment of a battery 200 that can be used in a battery pack according to the present invention. The battery 200 contains stacked repeating layers of current collectors 202, anode layers 208, solid-state electrolyte layers 204, and cathode layers 206. Each of these four items make up an individual electrochemical cell 210 which are repeated in a bipolar configuration. Each of the electrochemical cells 210 share a current collector with both of its adjacent cells. The battery 200 contains a positive terminal current collector 203 and a negative terminal current collector 205. The battery 200 also includes a case 212. The current collectors 202, anode layers 208, solid-state electrolyte layers 204, cathode layers 206, positive terminal current collector 203, and negative terminal current collector 205 may have the same planar shape and may be directly superimposed over one another in the layered structure.

### Current Collector

An electrochemical cell 210 of the battery 200 can be constructed such that the anode and cathode share a common current collector, and the cell is considered bipolar. The current collectors can comprise a material selected from the group consisting of nickel, molybdenum, titanium, zirconium, tantalum, alloy steel, stainless steel, nickel based super alloys (e.g., Inconel), cobalt based super alloys, copper, aluminum, or mixtures thereof. In some embodiments, the current collector may have a thickness between 1 nanometer and 100 micrometers, between 10 nanometers and 60 micrometers, or between 900 nanometers and 25 micrometers.

### Solid-State Electrolyte

The solid-state electrolyte material present in the electrochemical cell 210 of the battery 200 of the current disclosure may be any suitable solid electrolyte capable of conducting metal ions. For example, the solid-state electrolyte may be lithium phosphorous oxynitride (LiPON). The solid-state electrolyte may be an oxide based garnet such as lithium lanthanum zirconium oxide (LLZO), aluminum doped LLZO, niobium doped LLZO, or tantalum doped LLZO. The solid-state electrolyte may be a sodium super ionic conductor (NaSICON) such as lithium aluminum titanium phosphate (LATP). The solid-state electrolyte may be lithium super ionic conductor (LiSICON). The solid-state electrolyte may be a thio-LISICON. The solid-state electrolyte may be lithium aluminum germanium phosphate (LAGP). The solid-state electrolyte may be sulfide glass such as lithium phosphorous sulfide (LPS). The solid-state electrolyte may be a polymer such as polyethylene oxide (PEO), polyacrylonitrile (PAN), or a crystalline thermoplastic polymer. The solid-state electrolyte may comprise a mixture of any of the electrolytes listed above. In some embodiments, the solid-state electrolyte may have a thickness between 1 nanometer and 100 micrometers, between 100 nanometers and 50 micrometers, or between 1 micrometer and 25 micrometers.

### Cathode Active Materials

The cathode active material present in the electrochemical cell 210 of the battery 200 of the current disclosure may comprise layered oxides such as lithium cobalt oxide (LCO), lithium nickel manganese cobalt oxide (NMC such as NMC 111, 622, or 811), lithium nickel oxide (LNO), or lithium nickel cobalt aluminum oxide (NCA). The cathode active material may comprise olivine phosphates such as lithium iron phosphate (LFP), lithium nickel phosphate (LNP), lithium cobalt phosphate (LCP), or lithium manganese phosphate (LMP). The cathode active material may comprise a spinel oxide such as lithium manganese oxide (LMO) or lithium nickel manganese oxide (LMNO). The cathode active material may comprise disordered rock salt oxides such as lithium nickel zirconium oxide, lithium zirconium oxide, lithium magnesium zirconium oxide, lithium nickel tantalum oxide, or lithium niobium oxide. The cathode active material may comprise conversion cathodes such as lithium iron sulfide, lithium copper fluoride or lithium iron fluoride, or mixtures thereof. The cathode active material may comprise sulfur, lithium titanium sulfide, or vanadium oxide. The cathode active material may comprise a mixture of any of these materials. In some embodiments, the cathode active material may have a thickness between 1 nanometer and 400 micrometers, between 10 micrometers and 200 micrometers, or between 50 micrometers and 150 micrometers.

### Anode Active Materials

In one embodiment, the battery 200 is a lithium ion battery. A suitable active material for the anode of the lithium ion battery is a lithium host material capable of incorporating and subsequently releasing lithium ions such as graphite (artificial, natural), a lithium metal oxide (e.g., lithium titanium oxide), hard carbon, a tin/cobalt alloy, or silicon/carbon. The anode active material can be a mixture of any number of these anode active materials. The present invention is not limited to lithium ion batteries. In alternative embodiments, a suitable anode can comprise a magnesium host material capable of incorporating and subsequently releasing magnesium ions, or a sodium host material capable of incorporating and subsequently releasing sodium ions, or zinc host material capable of incorporating and subsequently releasing zinc ions. Suitable alternative cathode and electrolyte materials can be selected for such magnesium ion batteries, sodium ion batteries, or zinc ion batteries. For example, a sodium ion battery can include: (i) an anode comprising sodium ions, (ii) a solid state electrolyte comprising a metal cation-alumina (e.g., sodium-β-alumina or sodium-β″-alumina), and (iii) a cathode comprising an active material selected from the group consisting of layered metal oxides, (e.g., NaFeO, NaMnO, NaTIO, NaNiO, NaCrO, NaCoO, and NaVO) metal halides, polyanionic compounds, porous carbon, and sulfur containing materials.

In one embodiment, the battery 200 is a lithium metal battery. The anode of the lithium metal battery can comprise lithium metal. In one embodiment, the anode of the lithium metal battery consists essentially of lithium metal. The present invention is not limited to lithium metal batteries. In alternative embodiments, a suitable anode can comprise magnesium metal, sodium metal, or zinc metal. Suitable alternative cathode and electrolyte materials can be selected for such magnesium metal batteries, sodium metal batteries, or zinc metal batteries.

### Case

In one non-limiting example embodiment of a battery case shown in FIGS. 1-3, the case 212 comprises a multi-sided wall 230 including a wall section 231, a wall section 232, a wall section 233, a wall section 234, a wall section 235, a wall section 236, a wall section 237, a wall section 238, a wall section 239, a wall section 240, a wall section 241, and a wall section 242. The multi-sided wall 230 connects a first end wall 243, and a second end wall 244 of the case 212. The case 212 includes a first inwardly directed recess 245, and an opposite second inwardly directed recess 246. The first end wall 243 and the second end wall 244 each include a first end section 247, a second end section 248, and an intermediate section 249 connecting the first end section 247 and the second end section 248. It can be seen from FIGS. 1-3 that the case 212 has a complementary cross-sectional shape to the current collectors 202, anode layers 208, solid-state electrolyte layers 204, cathode layers 206, positive terminal current collector 203, and negative terminal current collector 205 of the battery 200. The case 212 has a cathode terminal tab 223 in electrical communication with the positive terminal current collector 203, and an anode terminal tab 225 in electrical communication with the negative terminal current collector 205.

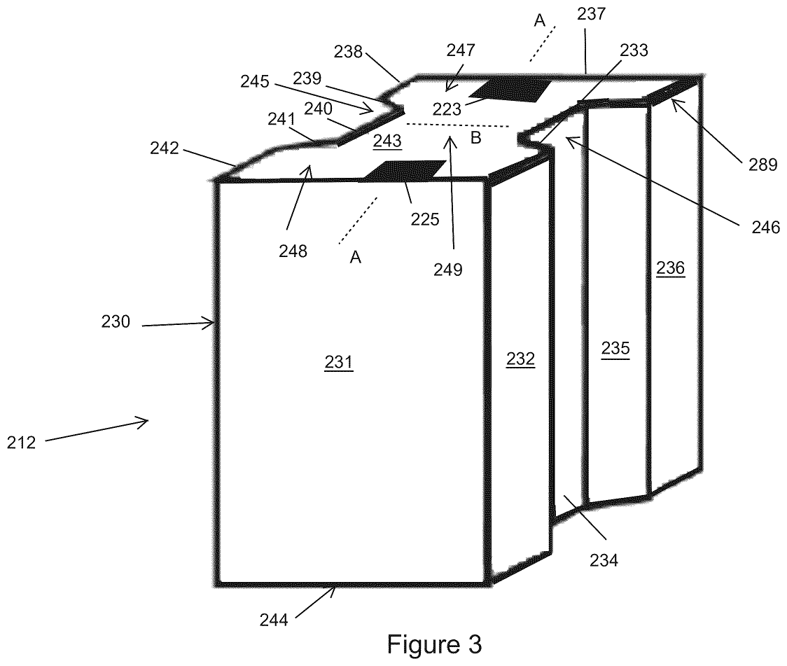

Looking at FIG. 3, it can be seen that a longitudinal axis A of the first end wall 243 and the opposite second end wall 244 of the case 212 is an axis of symmetry for the case 212. Also, a lateral axis B of the first end wall 243 and the opposite second end wall 244 of the case 212 is an axis of symmetry for the case 212. The case 212 includes an insulating layer facing the electrochemical cells 210 and current collectors of the battery 200. The insulating layer may comprise, for example, a polymeric material or a ceramic material. The insulating layer may be in contact with an optional outer layer of the case 212. The outer layer may comprise, for example, a different polymeric material or a different ceramic material or a metallic material (e.g., deep drawn aluminum).

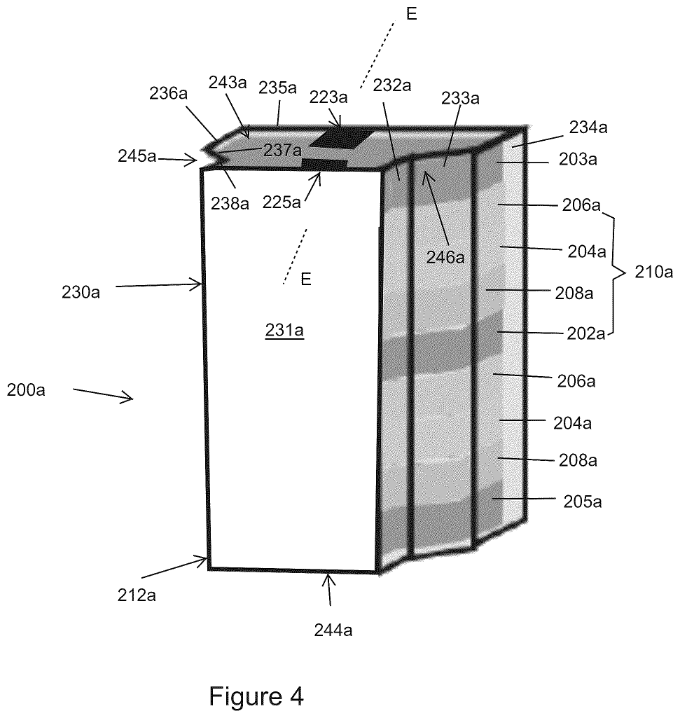

Numerous shapes of case and the complementary shaped current collectors, anode layers, solid-state electrolyte layers, cathode layers, positive terminal current collector, and negative terminal current collector of the battery are possible. For example, another non-limiting example embodiment of a battery 200a is shown in FIG. 4. The battery 200a can be used in a battery pack according to the present invention. The battery 200a contains stacked repeating layers of current collectors 202a, anode layers 208a, solid-state electrolyte layers 204a, and cathode layers 206a. Each of these four items make up an individual electrochemical cell 210a which are repeated in a bipolar configuration. Each of the electrochemical cells 210a share a current collector with both of its adjacent cells. The battery 200a contains a positive terminal current collector 203a and a negative terminal current collector 205a. The battery 200 also includes a case 212a. The current collectors 202a, anode layers 208a, solid-state electrolyte layers 204a, cathode layers 206a, positive terminal current collector 203a, and negative terminal current collector 205a may have the same planar shape and may be directly superimposed over one another in the layered structure.

The case 212a comprises a multi-sided wall 230a including a wall section 231a, a wall section 232a, a wall section 233a, a wall section 234a, a wall section 235a, a wall section 236a, a wall section 237a, and a wall section 238a. The multi-sided wall 230a connects a first end wall 243a, and a second end wall 244a. The case 212a includes a first inwardly directed recess 245a, and an opposite second inwardly directed recess 246a. It can be seen from FIG. 4 that the case 212a has a complementary cross-sectional shape to the current collectors 202a, anode layers 208a, solid-state electrolyte layers 204a, cathode layers 206a, positive terminal current collector 203a, and negative terminal current collector 205a of the battery 200a. The case 212a has a cathode terminal tab 223a in electrical communication with the positive terminal current collector 203a, and an anode terminal tab 225a in electrical communication with the negative terminal current collector 205a.

Looking at FIG. 4, it can be seen that a longitudinal axis E of the first end wall 243a and the opposite second end wall 244a of the case 212a is an axis of symmetry for the case 212a. The case 212a includes an insulating layer facing the electrochemical cells 210a and current collectors of the battery 200a. The insulating layer may comprise, for example, a polymeric material or a ceramic material. The insulating layer may be in contact with an optional outer layer of the case 212a. The outer layer may comprise, for example, a different polymeric material or a different ceramic material or a metallic material (e.g., aluminum).

### Enclosure

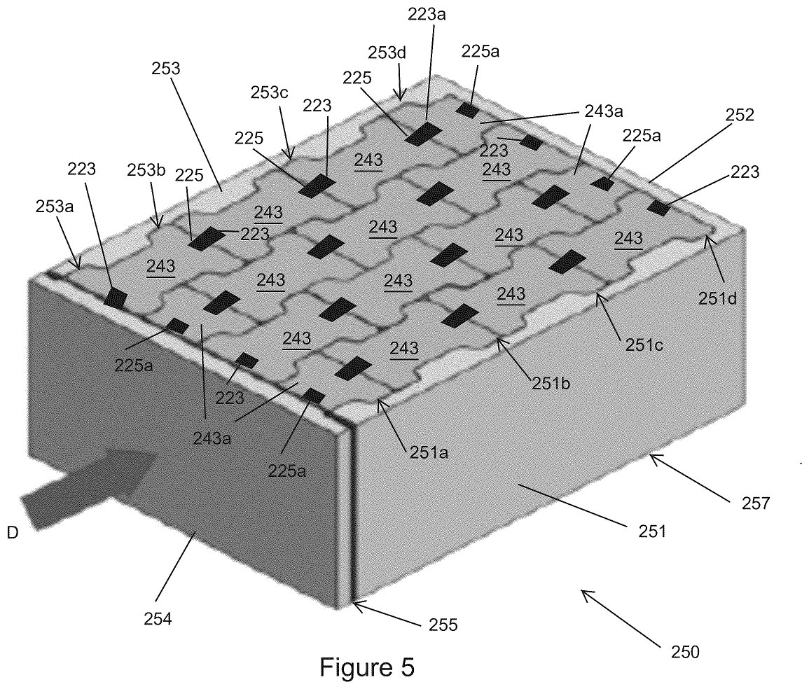

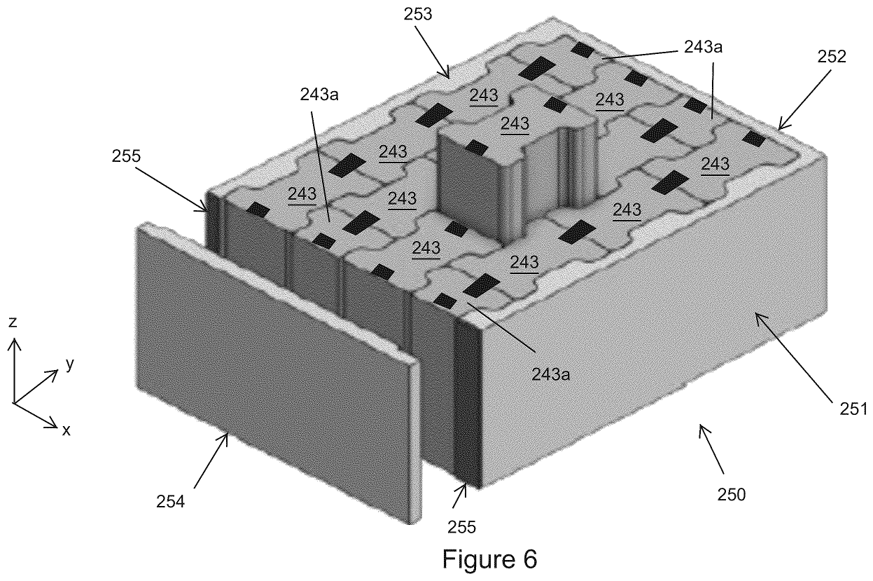

Looking at FIGS. 5 and 6, the battery pack includes an enclosure 250 having a first side wall 251, a second side wall 252, a third side wall 253, a removable side wall 254, and a floor 257. The first side wall 251 has indentations 251a, 251b, 251c, 251d, and the third side wall 253 has indentations 253a, 253b, 253c, 253d. The enclosure 250 can comprise a polymeric material or a ceramic material or a metallic material. After the batteries 200, 200a are assembled in the enclosure 250 as shown in FIG. 5, the removable side wall 254 is moved in direction D and adhered using adhesive 255 to the end surfaces of the first side wall 251, the third side wall 253, and the floor 257.

### Cover

The battery pack of the invention comprises a cover 260 dimensioned to engage the plurality of connected side walls 251, 252, 253 and the removable side wall 254 of the enclosure 250. The cover 260 includes a plurality of electrical contacts 261-280 and a wiring pattern 281 for placing the cathode terminal tabs 223, 223a and the anode terminal tabs 225, 225a of the batteries 200, 200a in electrical communication when the battery pack is assembled. The cover can include a positive electrical connection and negative electrical connection for placing the battery pack in electrical communication with the battery management system of the vehicle.

In another embodiment, the cover is dimensioned to engage the plurality of connected side walls and the removable side wall of the enclosure, wherein the cover is an electrically patterned cover. This embodiment of the cover provides a safety advantage in disassembly by electrically isolating each cell upon the opening of the cover (i.e., the first step of disassembly).

### Assembly of the Battery Pack

The battery pack of the invention is assembled as follows. An empty enclosure 250 is provided. A first row of two batteries 200 and two batteries 200a is placed in contact with an inner surface of the second side wall 252 of the enclosure 250 as shown in FIG. 5. A protruding portion of the first end section 247 of the first end wall 243 of the farthest right battery 200 in the first row is positioned in the indentation 251d of the first side wall 251. A protruding portion of the first end section of the first end wall 243a farthest left battery 200a in the first row is positioned in the indentation 253d of the third side wall 253. A second row of two batteries 200 is then placed in contact with the end walls of the batteries 200a in the first row as shown in FIG. 5. A protruding portion of the first end section 247 of the first end wall 243 of the farthest left battery 200 in the second row is positioned in the indentation 253d of the third side wall 253. This process can be repeated for each additional row of batteries placed in the enclosure 250. Due to the complementary shapes of the batteries 200, 200a, an interlocking pattern of the batteries 200, 200a is created in the enclosure 250. The batteries 200, 200a need not be secured together using fasteners or adhesive when the batteries 200, 200a are arranged within the enclosure 250. It can be appreciated that the order of placement of the batteries 200, 200a in the enclosure can vary.

After the batteries 200, 200a are assembled in the enclosure 250 as shown in FIG. 5, the removable side wall 254 is moved in direction D and adhered using adhesive 255 to the end surfaces of the first side wall 251, the third side wall 253, and the floor 257. In one embodiment, the adhesive 255 is selected from reversible adhesives that exhibit switchable adhesion controllable by a stimulus such as a light stimulus, an electrical stimulus, a thermal stimulus, or a magnetic stimulus. A non-limiting example of a reversible adhesive that exhibits switchable adhesion controllable by a light stimulus is an adhesive based on azobenzene-containing materials. A non-limiting example of a reversible adhesive that exhibits switchable adhesion controllable by an electrical stimulus is an adhesive based on an ion elastomer junction. A non-limiting example of a reversible adhesive that exhibits switchable adhesion controllable by a thermal stimulus is photo-sensitive ionic crystal (IC)-based adhesive. A non-limiting example of a reversible adhesive that exhibits switchable adhesion controllable by a magnetic stimulus is an adhesive based on elastomer and magnetic particles.

In another embodiment, after the batteries 200, 200a are assembled in the enclosure 250 as shown in FIG. 5, the removable side wall 254 is moved in direction D and fastened using mechanical screws.

### Disassembly of the Battery Pack

The interlocking pattern of the batteries 200, 200a can be designed in such a way that the preload exerted by the enclosure 250 will distribute the load evenly among cells in the x-y-direction. See FIG. 6. The battery pack of the invention can be disassembled to allow for repair and/or replacement of one or more of the batteries as shown in FIG. 6. Upon disassembly, the preload is released by debonding the reversible adhesive by a applying a stimulus such as a light stimulus, an electrical stimulus, a thermal stimulus, or a magnetic stimulus to the adhesive 255, depending on the reversible adhesive used. This enables the retrieval of individual cells in the z-direction as shown in FIG. 6. After placement of a new or repaired battery in a location of the batteries in the enclosure 250, the removable side wall 254 is moved in direction D (see FIG. 5) and adhered again using adhesive 255 to the end surfaces of the first side wall 251, the third side wall 253, and the floor 257. The assembly and disassembly concepts of the invention enable prolonged battery pack life through in-situ repair and reversible assembly through reversibly preloaded battery case tiling.

In another embodiment, the interlocking pattern of the batteries 200, 200a can be designed in such a way that the preload exerted by the enclosure 250 will distribute the load evenly among cells in the x-y-direction. The battery pack of the invention can be disassembled to allow for repair and/or replacement of one or more of the batteries as shown in FIG. 6. Upon disassembly, the preload is released by removing the mechanical screws that secure the removable side wall 254 to the end surfaces of the first side wall 251, the third side wall 253, and the floor 257. After placement of a new or repaired battery in a location of the batteries in the enclosure 250, the removable side wall 254 is moved in direction D (see FIG. 5) and secured again using screws to the end surfaces of the first side wall 251, the third side wall 253, and the floor 257. The assembly and disassembly concepts of the invention enable prolonged battery pack life through in-situ repair and reversible assembly through reversibly preloaded battery case tiling.

Thus, the invention provides a reversible cell-to-pack assembly for battery electric vehicles with no fasteners, wherein cells are tiled in a preloaded interlocking pattern in a battery enclosure closed by debondable adhesive.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in some embodiments”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A battery pack comprising:
an enclosure; and
a plurality of batteries arranged within the enclosure, each battery including one or more electrochemical cells and a case structured to contain the one or more electrochemical cells in an interior space of the case, each case comprising a first end wall, an opposite second end wall, and a multi-sided wall connecting the first end wall and the second end wall thereby defining the interior space of the case,
wherein a multi-sided wall of the case of at least one of the batteries comprises at least one inwardly directed recess having a first section dimensioned to matingly engage a second section of a multi-sided wall of another of the batteries when the plurality of batteries are arranged within the enclosure.

2. The battery pack of claim 1 wherein:
the first section of the multi-sided wall of the case of the at least one of the batteries is dimensioned to matingly engage a third section of a multi-sided wall of an additional one of the batteries when the plurality of batteries are arranged within the enclosure.

3. The battery pack of claim 2 wherein:
a first end wall of the case of the another of the batteries matingly engages a second end wall of the additional one of the batteries when the plurality of batteries are arranged within the enclosure.

4. The battery pack of claim 1 wherein:
the enclosure comprises a floor, a plurality of connected side walls extending upward from the floor and defining an opening between a pair of the connected side walls, and a removable side wall dimensioned to close off the opening.

5. The battery pack of claim 4 wherein:
the removable side wall is adhered to the pair of the connected side walls using an adhesive to close off the opening.

6. The battery pack of claim 5 wherein:
the adhesive is selected from reversible adhesives that exhibit switchable adhesion controllable by a stimulus.

7. The battery pack of claim 6 wherein:
the stimulus is at least one of a light stimulus, an electrical stimulus, a thermal stimulus, or a magnetic stimulus.

8. The battery pack of claim 4 wherein:
at least one of the pair of the connected side walls includes an indentation dimensioned to matingly engage a third section of the multi-sided wall of the another of the batteries when the plurality of batteries are arranged within the enclosure.

9. The battery pack of claim 1 wherein:
each of the plurality of batteries has a cross-sectional geometry to form an interlocking pattern of the plurality of batteries when the plurality of batteries are arranged within the enclosure.

10. The battery pack of claim 9 wherein:
the interlocking pattern distributes load evenly among the plurality of batteries cells in a longitudinal direction and a lateral direction due to a preload exerted by the enclosure.

11. The battery pack of claim 10 wherein:
the removable side wall is adhered to the pair of the connected side walls using a reversible adhesive to close off the opening, and
the preload is released by debonding the reversible adhesive enabling retrieval of individual batteries of the plurality of batteries in a direction transverse to a longitudinal axis of the enclosure.

12. The battery pack of claim 10 wherein:
the removable side wall is adhered to the pair of the connected side walls using a reversible adhesive to close off the opening, and
the preload is released by debonding the reversible adhesive enabling non-destructive selective disassembly of the plurality of batteries.

13. The battery pack of claim 10 wherein:
the removable side wall is secured to the pair of the connected side walls using screws.

14. The battery pack of claim 1 wherein:
each electrochemical cell includes a cathode, an anode, a solid state electrolyte positioned between the cathode and the anode, and a current collector in contact with one of the anode or the cathode; and
each battery further comprises:
(a) one or more electrochemical cells, each electrochemical cell including a cathode, an anode, a solid state electrolyte positioned between the cathode and the anode, and a current collector in contact with one of the anode or the cathode,
(b) a first terminal current collector comprising the current collector in contact with the one of the anode or the cathode of one of the electrochemical cells, and
(c) a second terminal current collector in contact with (i) the cathode of one of the electrochemical cells when the first terminal current collector comprises the current collector in contact with the anode of one of the electrochemical cells, or (ii) the anode of one of the electrochemical cells when the first terminal current collector comprises the current collector in contact with the cathode of one of the electrochemical cells.

15. The battery pack of claim 1 further comprising:
a cover dimensioned to engage the plurality of connected side walls and the removable side wall of the enclosure,
wherein the cover includes a plurality of electrical contacts for placing the first terminal current collector of one of the plurality of batteries in electrical communication with the second terminal current collector of an adjacent battery of the plurality of batteries, and
wherein the plurality of electrical contacts are in electrical communication.

16. The battery pack of claim 1 further comprising:
a cover dimensioned to engage the plurality of connected side walls and the removable side wall of the enclosure,
wherein the cover includes an electrical pattern for placing the first terminal current collector of one of the plurality of batteries in electrical communication with the second terminal current collector of an adjacent battery of the plurality of batteries.

17. The battery pack of claim 1 wherein:
the multi-sided wall of the case of the at least one of the batteries comprises a first inwardly directed recess on a first side of the multi-sided wall and a second inwardly directed recess on an opposite second side of the multi-sided wall,
a first section of the first inwardly directed recess is dimensioned to matingly engage a second section of a multi-sided wall of another of the batteries when the plurality of batteries are arranged within the enclosure, and
a second section of the second inwardly directed recess is dimensioned to matingly engage a third section of a multi-sided wall of an additional one of the batteries when the plurality of batteries are arranged within the enclosure.

18. The battery pack of claim 1 wherein:
the first end wall and the opposite second end wall of the case of at least some of the batteries each have a perimeter having a first end section having a first lateral width, a second end section having a second lateral width, and an intermediate section having a third lateral width, the intermediate section connecting the first end section and the second end section, and
the first lateral width is greater than the third lateral width, and
the second lateral width is greater than the third lateral width.

19. The battery pack of claim 18 wherein:
a longitudinal axis of the first end wall and the opposite second end wall of the case of at some of the batteries is an axis of symmetry.

20. The battery pack of claim 19 wherein:
a lateral axis of the first end wall and the opposite second end wall of the case of at some of the batteries is an axis of symmetry.

21. The battery pack of claim 18 wherein:
the first end wall and the opposite second end wall of the case of at least some of the batteries each have a perimeter having a first end section having a first lateral width, and a second end section having a second lateral width, and
the first lateral width is greater than the second lateral width.

22. The battery pack of claim 1 wherein:
the plurality of batteries are not secured together using fasteners or adhesive when the plurality of batteries are arranged within the enclosure.
